(19) United States
(12) Patent Application Publication
(10) Pub. No.: US 2005/0212219 A1
(43) Pub. Date: Sep. 29, 2005

(54) Flat gasket

(76) Inventors: Thomas Langenbach, Weite feld (DE); Markus Wagener, Hamm / Sieg (DE); Ralf Flemming, Langenbach (DE)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 11/089,672

(22) Filed: Mar. 25, 2005

(30) Foreign Application Priority Data
Mar. 26, 2004 (DE) 10 2004 014 869.4

(51) Int. Cl. F02F 11/00

(52) U.S. Cl. 277/592

(57) ABSTRACT

A gasket includes at least one layer having a sealing surface that is at least partially coated with an elastomer base layer. A second, elastically deformable, sealing material is applied to the elastomer base layer and isolates at least one area of said sealing surface that is free of any media-conveying holes.

### BACKGROUND OF THE INVENTION

1. Technical Field

The invention concerns a flat gasket, containing at least one layer, which indicates at least one sealing surface that is partially coated with an elastomer layer.

2. Related Art

U.S. Pat. No. 5,938,208 would indicate a metal flat gasket that displays at least one sealing plate, which can be positioned between a cylinder head and a motor block of an internal combustion engine. At least two layers are plated onto the sealing surfaces through a screen process at various positions of the respective sealing surface. Each respective coating has beaded areas. Here, it should be mentioned that the surface coating can be applied both in the area of the beading as well as outside of this area.

A cylinder head gasket is described in WO 00/70245 containing one sealing plate, which has at least one metallic coating with elastic characteristics, and into which a passage has been drilled. This passage opening is enclosed by crimping in this metal layer. The corrugation, built into the gasket sealing, forms an approximately linear sealed zone closed into itself with increased sealing surface pressing. A first coating of a synthetic compound displaying elastic characteristics is applied to the metal layer on the side forming its sealed zones, at least in the area of these sealed zones as well as on both sides of the latter. To improve the sealing capacity of the cylinder head gasket, the metal layer around the passage opening in question has an enclosed, bulged surface coating made of a synthetic compound on the side with the first layer. The metal layer is arranged on the side of the sealing area that is turned away from the passage opening, and it is set in radial distance in relation to the passage opening. Here, the ridge of the bulged surface is further away from the metal layer bearing it than from the topside of the first coating. With the current status of this procedure, the media of the foremost passage holes are completely surrounded by the second elastomer layer.

Scratches, grooves, etc. may develop on the motor components through the mechanical processing of the surfaces. These imperfections may be greater than 30 μm and are likely to cause leakages, as they cannot be sealed with the usual coating thickness of the sealing surfaces (ca. 25 μm). The current status of the procedure for the above-mentioned gasket sealing reveals continuous media channels, through which the substance reaches the cylinder heads via the media-guiding channels of the cylinder head gasket. The material is transported further in a corresponding manner. For motors having motor blocks with open media-transporting canals that lead upward, yet do not continue into the cylinder heads, other sealing problems are presented regarding the above-mentioned grooves.

### SUMMARY OF THE INVENTION AND ADVANTAGES

The invention's function is fundamentally to prepare a cylinder head surface allowing the demonstrated leakage problems to be solved through simple measures yet without increasing production costs significantly.

This problem is solved by a flat gasket containing at least one layer which has a sealing surface coated, at least partially, with one elastomer layer. Recesses to guide the materials and passage holes are inserted as needed into this sealing surface. Here again, the coating is at least partially beaded, and additional sealing surfaces formed from elastic, malleable materials are provided in the areas without recesses or passage holes.

Thanks to the invention, areas for which the media-guiding channels are exclusively in the area of the motor block or the cylinder head can now be sealed. An unperforated gasket seal in these areas is, thus, used in the media-guiding areas of the cylinder block or the cylinder head, and is provided exactly here with the sealing surfaces facing the appropriate channels. Thus, it is no longer possible for the medium to penetrate the unsealed areas of the cylinder block of the respective motor head, nor can it escape through grooves or scratches. Contingent upon the second, additional material plated onto the first coating of the surface areas, the medium can extrude through the grooves or scratches caused by the workings and can fill these grooves or scratches itself.

### THE DRAWINGS

The invention is presented by means of an embodiment in the drawing, and is described as follows:

FIG. 1 is a single-layered cylinder head gasket seen from above;

FIG. 2 is a cylinder head gasket as per FIG. 1 when seen from below;

FIG. 3 is a cross-section indicated by line A-A in FIG. 2; and

FIGS. 4-6 show various positions of the additional sealing surfaces.

### DETAILED DESCRIPTION

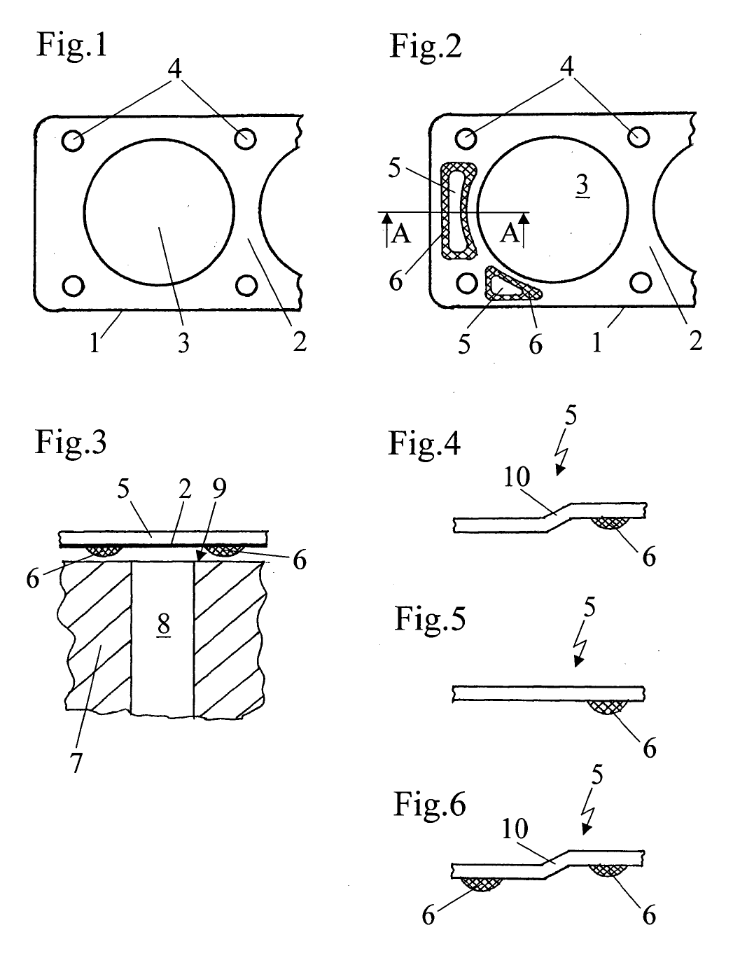

FIG. 1 shows a partial view of a cylinder head gasket 1, which in this example is completely covered with a 0.25 μm-thick elastomer layer 2. Cylinder head gasket 1 should indicate combustion chamber holes 3 and screw holes 4 in this example. At the available positions, media-guiding recesses (not depicted further) may be positioned. These are not included here so as to show the invention more clearly.

FIG. 2 shows the cylinder head gasket as per FIG. 1 when seen from below. Excluding the recesses that are not depicted further (respectively the represented funnel-through holes 3, 4), additional sealing areas 6 are depicted on the level sealing surfaces 5. These additional sealing areas 6 are composed of elastic, deformable materials, which can be applied onto the elastomer layer 2 of the cylinder head gasket 1 through, e.g., a partial screen process.

These additional sealing areas 6 can be added, as needed, at various unperforated positions on the cylinder head gasket 1 according to the formal design of the cylinder head gasket 1. This will form other sealing areas to prevent leakage.

FIG. 3 shows a possibility where such an additional sealing area 6 is logically applied. The indicated motor block 7 is recognizable as having media-guiding channels 8, which in this example, however, should not lead into the cylinder head (not depicted again). The provided unperforated, level sealing surface 5 in this special area 8 of the motor block 7 preferably comprises a fluorine polymer screen process printing 6 on top of the elastomer layer 2. This fluorine polymer printing faces the direction of the related face surfaces 9 of motor block 7. The additional sealing area 6 is adapted to the contour of the media-guiding recess 8 and surrounds this recess to seal it. Where applicable grooves in the area of the face surfaces 9 that were produced during production and can be securely and permanently sealed by the extrusion of fluorine polymer 6 into these grooves. The fluorine polymer may include sililcon. The combined thickness of the estomer base layer 2 and the additional elastomer layer 6 is preferably between 0.3 μm and 0.5 μm.

FIGS. 4 through 6 show possible areas for implementation of the additional sealing surface 6. The flat, unperforated sealing surface 5 is recognizable, and beads 10 can be inserted on this as needed, such as half beads as illustrated. The elastomer material forming the additional sealing area 6 is assigned to sealing surface 5 outside of the respective beads 10. As already mentioned, the contour of the additional area 6 corresponds normally to the outside contour of the respective media-guiding channel 8.

1. A gasket comprising:
at least one layer having a sealing surface that is at least partially coated with an elastomer base layer; and
a second, elastically deformable, sealing material applied to said elastomer base layer and isolating at least one area of said sealing surface that is free of any media-conveying holes.

2. The gasket of claim 1 wherein said second sealing material defines a closed loop figure about said at least one isolated area.

3. The gasket of claim 2 wherein said isolated area is flat.

4. The gasket of claim 2 wherein there are a plurality of said isolated areas.

5. The gasket of claim 1 wherein said second sealing material comprises a fluorine polymer material.

6. The gasket of claim 5 wherein said fluorine polymer includes silicon.

7. The gasket of claim 1 wherein said base layer and said second sealing material have a combined thickness of between about 0.3 and 0.5 μm.

8. The gasket of claim 7 wherein said base layer has a thickness of about 0.25 μm.

9. The gasket of claim 1 wherein said second sealing material is screen printed onto said base layer.

10. The gasket of claim 1 wherein said at lest one layer includes a bead.

11. The gasket of claim 10 wherein said bead comprises a half bead and said at least one isolated area is located outside of said bead.

12. A gasket and component combination comprising
a component having a plurality of media-conveying passages open to a surface to be sealed;
a gasket disposed on said surface having at least one gasket layer coated with an elastomer base layer and formed with at least one media-conveying hole communicating with at least one of said plurality of media-conveying passages of said component, and including a second, elastically deformable, sealing material applied to said base layer and isolating at least one area of said sealing surface that is free of any media-conveying holes and communicating with at least another of said plurality of said media-conveying passages of said component so as to seal off said another of said media-conveying passages of said component.
